(19) United States
(12) Patent Application Publication
(10) Pub. No.: US 2009/0191306 A1
(43) Pub. Date: Jul. 30, 2009

(54) NUTRITIONAL COMPOSITION CONTAINING DHA, RUMENIC ACID, AND GANGLIOSIDES

(75) Inventor: Deshanie Rai, Evansville, IN (US)

Correspondence Address: WADDEY & PATTERSON, P.C., 1600 DIVISION STREET, SUITE 500, NASHVILLE, TN, 37203, US

(73) Assignee: Bristol-Myers Squibb Company

(21) Appl. No.: 12/272,891

(22) Filed: Nov. 18, 2008

Related U.S. Application Data
(60) Provisional application No. 61/023,940, filed on Jan. 28, 2008.

(51) Int. Cl. A23L 1/305; A23C 9/152; A23K 1/18

(52) U.S. Cl. 426/2; 426/648; 426/580

(57) ABSTRACT

In accordance with the present invention, a nutritional composition, a method for enhancing the immune system development in an infant, and a method for reducing allergic inflammatory responses in an infant are provided. The nutritional composition comprises a protein source, a fat source, a carbohydrate source, rumenic acid, DHA, and at least one ganglioside. Both methods comprise administering to the infant a combination of rumenic acid, DHA, and at least one ganglioside.

### CROSS-REFERENCE TO RELATED PATENT APPLICATIONS

This application claims the priority benefit of U.S. Provisional Application No. 61/023,940 filed Jan. 28, 2008, which is incorporated by reference herein in its entirety.

### BACKGROUND OF THE INVENTION

The present invention relates generally to nutritional compositions containing docosahexaenoic acid (DHA), rumenic acid, and gangliosides.

### SUMMARY OF THE INVENTION

In an embodiment, the present invention is directed to an nutritional composition comprising a protein source, a fat source, a carbohydrate source, rumenic acid, DHA, and at least one ganglioside.

The nutritional composition of the invention may be useful in enhancing immune system development and/or function in an infant by administering a combination of ingredients comprising rumenic acid, DHA, and at least one ganglioside to the infant.

The nutritional composition of the invention may also be useful in reducing allergic inflammatory responses in an infant by administering a combination of ingredients comprising rumenic acid, DHA, and at least one ganglioside to the infant.

### DETAILED DESCRIPTION OF THE PREFERRED EMBODIMENTS

Reference now will be made in detail to the embodiments of the invention, one or more examples of which are set forth below. Each example is provided by way of explanation of the invention, not a limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment.

Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

The present invention is directed, in an embodiment, to an nutritional composition comprising a protein source, a fat source, a carbohydrate source, rumenic acid, DHA, and at least one ganglioside.

Rumenic acid is a conjugated linoleic acid (CLA) found in the fat of ruminants and in dairy products. It is an omega-7 trans fat and its lipid shorthand name is cis-9, trans-11 18:2 acid. Its chemical formula is C₁₈H₃₂O₂ and its structure is shown below:

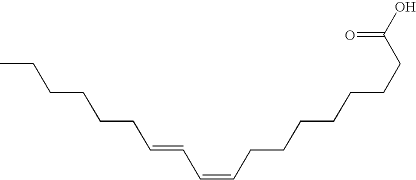

Of the individual isomers of CLA, rumenic acid has been implicated as the most biologically active. It is the predominant isomer incorporated into the phospholipids of cell membranes, liver phospholipids, and triglycerides. It is also the predominant dietary form of CLA, obtained from fats derived from human milk, ruminant animals, including milk, dairy products, and meat. In fact, in fat from ruminant meats and dairy products, rumenic acid is present as approximately 80% to 90% of the total CLA.

In an embodiment of the invention, rumenic acid is present in an amount ranging from about 0.01 to about 0.50 mg/g nutritional composition. In another embodiment of the invention, rumenic acid is present in an amount ranging from about 0.02 to about 0.30 mg/g nutritional composition.

If the composition of the invention is administered to an infant or child, an amount of rumenic acid ranging from about 50 mg to about 250 mg per day may be administered. In another embodiment, the amount of rumenic acid administered to an infant or child may range from about 50 mg to about 100 mg per day. In yet another embodiment, the amount of rumenic acid administered to an infant or child may range from about 60 mg to about 80 mg per day.

In certain embodiments, the invention contemplates the use of CLA and CLA derivatives as sources of rumenic acid. For example, if CLA is used as the source of rumenic acid, it may be free, bound through ester linkages, or provided in the form of an oil containing CLA triglycerides. If CLA triglycerides are utilized, the triglycerides may be partially or wholly comprised of CLA attached to a glycerol backbone. The CLA may also be provided as a methylester or ethylester. Furthermore, the CLA may be used in the form of a non-toxic salt, such as a potassium or sodium salt.

In another embodiment, the invention contemplates the use of vaccenic acid (11-trans-octadecenoic acid) as a source of rumenic acid, Vaccenic acid is a major trans fatty acid in milk fat and is a major precursor of CLA in milk fat. Desaturation of vaccenic acid to rumenic acid is catalyzed by Δ⁹-desaturase in humans. Turpeinen, et al., Bioconversion of Vaccenic Acid to Conjugated Linoleic Acid in Humans, Am. J. Clin. Nutr. 76: 504-510 (2002).

The nutritional composition of the invention also comprises DHA. DHA is a long chain polyunsaturated fatty acid (LCPUFA) found in high concentrations in the infant brain and retina. Sastry, P. S., Lipids of Nervous Tissue: Composition and Metabolism, Progress Lipid Res. 24:69-176 (1985); Fliesler, S. J., et al. Chemistry and Metabolism of Lipids in the Vertebrate Retina, Progress Lipid Res. 22:79-131 (1983). Chemically, DHA is a carboxylic acid with a 22-carbon chain and six cis double bonds, with the first double bond being located at the third carbon from the omega end. Thus, DHA is often referred to as an omega-three (ω-3) fatty acid. DHA is derived from the parent essential fatty acid α-linolenic acid through alternate desaturation and elongation.

The amount of DHA in the present invention may be from about 2 mg/100 kilocalories (kcal) to about 100 mg/100 kcal. In another embodiment, the amount of DHA may be from about 5 mg/100 kcal to about 75 mg/100 kcal. In yet another embodiment, the amount of DHA may be from about 15 mg/100 kcal to about 60 mg/100 kcal.

Some embodiments of the invention encompass the administration of the composition to an infant or child. In this embodiment, an infant may be between the age of birth and 1 year. In some embodiments, a child may be between the ages of about 1 year and 12 years. In some embodiments, the child may be between the ages of about 4 and 9 years.

If DHA is administered to an infant or child, the amount of DHA may be between about 2.5 mg/kg of body weight/day and about 60 mg/kg of body weight/day. In another embodiment, the amount of DHA administered may be between about 6 mg/kg of body weight/day and about 40 mg/kg of body weight/day. In yet another embodiment, the amount of DHA administered may be between about 12 mg/kg body weight/day and about 30 mg/kg body weight/day. In a still further embodiment, the amount of DHA administered may be between about 18 mg/kg of body weight/day and about 24 mg/kg of body weight/day.

The source of the DHA can be any source known in the art such as marine oil, fish oil, single cell oil, egg yolk lipid, brain lipid, and the like. In particular embodiments, the DHA may be sourced from the single cell Martek oil, DHASCO®, or variations thereof. The DHA can be in natural form, provided that it does not result in any substantial deleterious effect on the infant. Alternatively, the DHA can be used in refined form.

The nutritional composition also comprises at least one ganglioside. Gangliosides are compounds composed of glycosphingolipids with one or more sialic acid moieties (n-acetylneuraminic acid) linked on the sugar chain. They consist of a hydrophobic ceramide moiety and a hydrophilic oligosaccharide chain. Ceramide is a chimera of a sphingoid base and a fatty acid joined with an amide bond. The oligosaccharide chain is linked to the sphingoid base. Gangliosides are part of the membrane fraction of the milk fat globule, which derives from the apical plasma membrane of the secretory cells in the lactating mammary gland.

In an embodiment, the nutritional composition of the invention comprises at least one ganglioside. In this embodiment, the ganglioside may be selected from those known in the art that would be compatible with the other components of the invention. In an embodiment, the ganglioside is selected from the group consisting of monosialogangliosides, disialogangliosides, trisialogangliosides, quadrasialogangliosides, pentasialogangliosides, and combinations thereof.

Gangliosides are commonly defined by a short-hand nomenclature system in which “G” refers to a ganglioside, “M”, “D”, “T” “Q”, and “P” refer to mono-, di-, tri-, quadra- and pentasialogangliosides, respectively, and the subscript numbers 1, 2, 3, etc. refer to the order of migration of the gangliosides on thin-layer chromatography. The subscripts “a”, “b” and “c” indicate the series of conversion by glycosyltransferases and sialyltransferases into more complex gangliosides.

The ganglioside of the invention may be any ganglioside that is compatible with the other components of the invention. In some embodiments, the ganglioside is selected from the group consisting of GM₃, GM₂, GM₁, GD₃, GD₂, GD₁a, GD₁b, GT₃, GT₂, GT₁, GT₁b, GQ₁b, GP₁, and combinations thereof. In other embodiments, the gangliosides comprise GM₁, GD₁a, GD₁b, GT₁b, and GQ₁b.

In a particular embodiment of the invention, the gangliosides comprise GD₃ and GM₃. In this embodiment, GD₃ may comprise between about 20% and 40% of the total gangliosides and GM₃ may comprise about 20% and 40% of the total gangliosides. In another embodiment, GD₃ may comprise about 30% of the total gangliosides and GM₃ may comprise about 30% of the total gangliosides.

In yet another embodiment of the invention, the gangliosides comprise GM₃ and GD₃. In this embodiment, the GM₃ gangliosides may have a major fatty acid composition of 22:0, 18:0, 16:0, and 24:0. Similarly, the GD₃ gangliosides may have a major fatty acid composition of 18:0, 16:0, 19:0 and 22:0. In an embodiment, between about 30% and 60% of the fatty acids on the gangliosides of the present invention have a chain length of 20 or more carbon atoms. In another embodiment, between about 35% and 50% of the fatty acids on the gangliosides of the present invention have a chain length of 20 or more carbon atoms. In a particular embodiment, the fatty acids of the gangliosides of the present invention are selected from the group consisting of long chain polyunsaturated fatty acids, ofeic acid, fatty acids with 16 or fewer carbon atoms, and combinations thereof.

In an embodiment of the invention, the gangliosides are present in an amount of about 5 to 15 mg lipid-bound sialic acid (LBSA) per liter nutritional composition. In an embodiment of the invention, the gangliosides are present in an amount of about 7 to 12 mg LBSA per liter nutritional composition. In another embodiment, the gangliosides are present in an amount of about 9 to 10 mg LBSA per liter nutritional composition.

In an embodiment of the invention, the gangliosides are present in an amount which comprises about 0.005 to about 0.1 weight percent of the total weight of the composition. In another embodiment of the invention, the gangliosides are present in an amount which comprises about 0.01 to about 0.05 weight percent of the total weight of the composition.

For an infant or child, an amount of ganglioside ranging from about 1 mg to about 100 mg per day may be administered. In another embodiment, the amount of ganglioside administered to an infant or child may range from about 10 mg to about 50 mg per day.

In an embodiment, the nutritional composition can be an infant formula, a human milk supplement, a baby food, a baby cereal, a follow-on formula, or a children's nutritional product. As used herein, the term “infant formula” means a composition that satisfies the nutrient requirements of an infant by being a substitute for human milk. In a particular embodiment, the nutritional composition, infant formula, human milk supplement, or children's nutritional product is in a powdered form. In other embodiments, the nutritional composition, infant formula, human milk supplement, or children's nutritional product may be in a liquid or ready-to-use form.

In an embodiment, the infant formula for use in the present invention is nutritionally complete and contains suitable types and amounts of lipid, carbohydrate, protein, vitamins and minerals. The amount of lipid or fat typically can vary from about 3 to about 7 g/100 kcal. The amount of protein typically can vary from about 1 to about 5 g/100 kcal. The amount of carbohydrate typically can vary from about 8 to about 12 g/100 kcal. Protein sources can be any used in the art, e.g., nonfat milk, whey protein, casein, soy protein, hydrolyzed protein, amino acids, and the like. Carbohydrate sources can be any used in the art, e.g., lactose, glucose, corn syrup solids, maltodextrins, sucrose, starch, rice syrup solids, and the like. Lipid sources can be any used in the art, e.g., vegetable oils such as palm oil, canola oil, corn oil, soybean oil, palmolein, coconut oil, medium chain triglyceride oil, high oleic sunflower oil, high oleic safflower oil, and the like.

Conveniently, commercially available infant formula can be used. For example, Enfalac, Enfamil®, Enfamil® Premature Formula, Enfamil® with Iron, Enfamil® LIPIL®, Lactofree®, Nutramigen®, Pregestimil®, and ProSobee® (available from Mead Johnson & Company, Evansville, Ind., U.S.A.) may be supplemented with suitable levels of rumenic acid, DHA, and at least one ganglioside and used in practice of the invention.

In some embodiments of the invention, the nutritional composition contains additional components which may include probiotics, prebiotics, or additional long chain polyunsaturated fatty acids (LCPUFAs). The term “probiotic” means a microorganism that exerts beneficial effects on the health of the host. Any probiotic known in the art may be added, provided it is suitable for combination with the other components of the supplement. For example, the probiotic may be chosen from the group consisting of Lactobacillus and Bifidobacterium. Alternatively, the probiotic can be Lactobacillus rhamnosus GG.

In certain embodiments, the nutritional supplement of the present invention additionally comprises at least one prebiotic. The term “prebiotic”, as used herein, means a non-digestible food ingredient that stimulates the growth and/or activity of probiotics. In this embodiment, any prebiotic known in the art may be added, provided it is suitable for combination with the other components of the supplement. In a particular embodiment, the prebiotic can be selected from the group consisting of polydextrose, fructo-oligosaccharide, gluco-oligosaccharide, galacto-oligosaccharide, inulin, isomalto-oligosaccharide, xylo-oligosaccharide and lactulose.

In yet another embodiment of the invention, additional LCPUFAs may be supplemented into the nutritional composition. In this embodiment, the LCPUFA may comprise arachidonic acid (ARA). If used, the amount of ARA in the present invention may be from about 4 mg/100 kilocalories (kcal) to about 100 mg/100 kcal. In another embodiment, the amount of ARA may be from about 10 mg/100 kcal to about 67 mg/100 kcal. In yet another embodiment, the amount of ARA may be from about 20 mg/100 kcal to about 50 mg/100 kcal. In a particular embodiment, the amount of ARA may be from about 25 mg/100 kcal to about 40 mg/100 kcal. In one embodiment, the amount of ARA is about 30 mg/100 kcal.

The LCPUFA source may or may not contain eicosapentaenoic acid (EPA). In some embodiments, the LCPUFA used in the invention contains little or no EPA. For example, in certain embodiments that the infant formulas used herein contain less than about 20 mg/100 kcal EPA; in some embodiments less than about 10 mg/100 kcal EPA; in other embodiments less than about 5 mg/100 kcal EPA; and in still other embodiments substantially no EPA.

In a particular embodiment, the combination of rumenic acid, DHA, and at least one ganglioside provides an improvement in intestinal health. It is believed that the combination of these components may provide an improvement in both mucin quality and quantity, resist pathogenic bacterial adherence and promote beneficial bacterial adherence within the intestinal wall. Thus, it is believed that the combination of rumenic acid, DHA, and at least one ganglioside has a beneficial overall impact on intestinal health.

In some embodiments, the combination of rumenic acid, DHA, and at least one ganglioside aids in immune system development and/or function in mammals. For example, the combination of rumenic acid, DHA, and at least one ganglioside may enhance resistance to infection and/or reduce allergic inflammatory responses including, but not limited to asthma, wheezing, atopic cough, bronchiolitis, bronchitis, and eczema. Thus, in an embodiment, the invention is directed to a method for enhancing the immune response in an infant comprising administering a combination of rumenic acid, DHA, and at least one ganglioside to the infant. In another embodiment, the invention is directed to a method for enhancing resistance to infection in an infant comprising administering a combination of rumenic acid, DHA, and at least one ganglioside to the infant. In yet another embodiment, the invention is directed to a method for reducing allergic inflammatory responses in an infant comprising administering a combination of rumenic acid, DHA, and at least one ganglioside to the infant.

In certain embodiments, the combination of rumenic acid, DHA, and at least one ganglioside provides immune system enhancement and/or reduction of allergic inflammatory responses. It is believed that the activity of the combination of rumenic acid, DHA, and at least one ganglioside is greater than the added activity expected when each of these three compounds are administered separately.

In particular embodiments, the subject is “in need” of the composition of the invention. For example, a subject may be in need because he is immunocompromised, chronically ill, or is a premature infant. Thus, in one embodiment of the invention, the composition is administered to subjects in need of such treatment.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the preferred versions contained therein.

What is claimed is:

1. An nutritional composition comprising:
a. a protein source;
b. a fat source;
c. a carbohydrate source;
d. rumenic acid;
e. DHA; and
f. at least one ganglioside.

2. The nutritional composition according to claim 1, wherein the amount of rumenic acid is between about 0.01 to about 0.50 mg/g nutritional composition.

3. The nutritional composition according to claim 1, wherein the amount of DHA present is from about 2 mg/100 kilocalories to about 100 mg/100 kilocalories.

4. The nutritional composition according to claim 1, wherein the gangliosides are present in an amount from about 5 to about 15 mg lipid-bound sialic acid per liter nutritional composition.

5. The nutritional composition according to claim 1, wherein the gangliosides are present in an amount from about 0.005 to about 0.1 weight percent of the total weight of the composition.

6. The nutritional composition according to claim 1, wherein the ganglioside is selected from the group consisting of monosialogangliosides, disialogangliosides, trisialogangliosides, quadrasialogangliosides, pentasialogangliosides, and combinations thereof.

7. The nutritional composition according to claim 1, wherein the ganglioside is selected from the group consisting of GM₃, GM₂, GM₁, GD₃, GD₂, GD₁a, GD₁b, GT₃, GT₂, GT₁, GT₁b, GQ₁b, GP₁, and combinations thereof.

8. The nutritional composition according to claim 1, wherein the composition is an infant formula.

9. A method for enhancing immune system function in an infant comprising administering a combination of rumenic acid, DHA, and at least one ganglioside to the infant.

10. The method of claim 9 wherein the enhanced immune system function comprises an improved resistance to infection.

11. The method of claim 9, wherein the amount of rumenic acid administered to the infant is between about 50 mg to about 250 mg per day.

12. The method of claim 9, wherein the amount of DHA administered to the infant is between about 2.5 mg/kg of body weight of the infant per day to about 60 mg/kg of body weight of the infant per day.

13. The method of claim 9, wherein the amount of ganglioside administered to an infant is between about 1 mg and 100 mg per day.

14. A method for reducing allergic inflammatory responses in an infant comprising administering a combination of rumenic acid, DHA, and at least one ganglioside to the infant.

15. The method according to claim 14 wherein the inflammatory response being reduced is selected from the group consisting of asthma, wheezing, atopic cough, bronchiolitis, bronchitis, and eczema.

16. The method of claim 14, wherein the amount of rumenic acid administered to the infant is between about 50 mg to about 250 mg per day.

17. The method of claim 14, wherein the amount of DHA administered to the infant is between about 2.5 mg/kg of body weight of the infant per day to about 60 mg/kg of body weight of the infant per day.

18. The method of claim 14, wherein the amount of ganglioside administered to an infant is between about 1 mg and 100 mg per day.

19. A method for improving intestinal health in an infant comprising administering a combination of rumenic acid, DHA, and at least one ganglioside to the infant.

20. The method of claim 19 wherein the improvement in intestinal health is selected from the group consisting of an improvement in mucin quality, an improvement in mucin quantity, resistance to pathogenic bacterial adherence in the intestinal wall, promotion of beneficial bacterial adherence in the intestinal wall, and combinations thereof.
